(19) United States
(12) Patent Application Publication
(10) Pub. No.: US 2020/0166065 A1
(43) Pub. Date: May 28, 2020

(54) T-SLOT CONNECTION INSERT APPARATUSES AND METHODS OF MAKING AND USING THE SAME

(71) Applicant: Clayton Vowels, Crystal Lake, IL (US)

(72) Inventor: Clayton Vowels, Crystal Lake, IL (US)

(21) Appl. No.: 16/777,302

(22) Filed: Jan. 30, 2020

Related U.S. Application Data
(63) Continuation-in-part of application No. 16/684,223, filed on Nov. 14, 2019.
Application No. 16/684,223 is a continuation-in-part of application No. 16/434,805, filed on Jun. 7, 2019, now abandoned.
(60) Provisional application No. 62/682,211, filed on Jun. 8, 2018.

(51) Int. Cl. F16B 9/00; F16B 37/04

(52) U.S. Cl. CPC F16B 9/054; F16B 2200/10; F16B 37/045

(57) ABSTRACT

T-slot connection insert apparatuses comprise a first connector tab having a first connection aperture therein and a second connector tab having a second connection aperture therein, wherein the first connector tab and the second connector tab are connected together via a bridging span.

The present invention claims priority as a continuation-in-part application to U.S. patent application Ser. No. 16/684,223, titled “T-Slot Connection Insert Apparatuses and Methods of Making and Using the Same,” filed Nov. 14, 2019, which claims priority as a continuation-in-part application to U.S. patent application Ser. No. 16/434,805, titled “T-Slot Connection Insert Apparatuses and Methods of Making and Using the Same,” filed Jun. 7, 2019, which claims priority to U.S. Prov. Pat. App. No. 62/682,211, titled “T-Slot Connection Insert Apparatuses and Methods of Making and Using the Same,” filed Jun. 8, 2018, each of which is incorporated by reference herein in its entirety.

### TECHNICAL FIELD

The present invention relates to T-slot connection insert apparatuses. Specifically, typical T-slot aluminum frame pieces include one or more slots contained within the frame pieces to hold one or more connectors that may be positioned to allow components to be connected thereto. The present invention provides a T-slot connection insert apparatus comprising a first connector tab having a first connection aperture therein and a second connector tab having a second connection aperture therein, wherein the first connector tab and the second connector tab are connected together via a bridging span.

### BACKGROUND

T-slot aluminum frame pieces are used to provide modular frames having connection points therein at necessary and desired locations. The frame pieces are typically connected together to form a frame on which various components are attached. FIG. 1 illustrates a prior art T-slot frame piece. For example, a T-slot aluminum frame may be constructed using the modular T-slot aluminum frame pieces, and a component such as a piece of equipment may be attached thereto. FIG. 2 illustrates an exemplary prior art T-slot frame that may be constructed from T-slot frame pieces. Connectors, typically including a short tab of material, such as plastic, metal or other like material, are disposed within so-called “T-slots” within one or more of the surfaces of the T-slot aluminum frame pieces. FIG. 3 illustrates a plurality of typical prior art connectors that may be disposed within the T-slots of the frame pieces. The connectors typically include a single aperture within which is a thread for holding a bolt that may extend from a piece of equipment, and allow the piece of equipment to be bolted to the frame. FIG. 4 illustrates an example of a prior art connector disposed within a T-slot of a frame piece.

The connectors may be disposed within the slots of the T-slot frame pieces in any desired location, making the T-slot aluminum frame pieces desirable by users thereof. Thus, users may build modular frames from the T-slot aluminum frame pieces and position the connectors in the desired locations to easily bolt equipment thereto in particular locations on the frame. FIG. 5 illustrates a motor mounted to a T-slot frame. As illustrated the motor is bolted into a plurality of connectors within T-slots of the frame pieces in an illustration of prior art.

However, as useful as the T-slot frame pieces and connectors are, it is often difficult to align the connectors in position to accept bolts from equipment. Indeed, oftentimes equipment requires two or more connection points to securely connect the equipment to the T-slot frames. Although it may be somewhat easy to align a single connector with a single bolt on a piece of equipment, once the equipment is attached to one connector, aligning a second connector with a second bolt on the piece of equipment can be very difficult. This is so because the piece of equipment itself may interfere with a user's ability to reach and align the connector as desired.

Oftentimes, typical connectors slide freely within T-slots and as such become difficult to align with bolts on equipment. A slight bump to the frame may cause the connector to misalign, and a user may not realize it until he or she attempts to connect a bolt thereto. Once a misalignment is detected, the user may have to remove the equipment and reset the connector within the T-slot.

Moreover, because each connector is independently alignable within the T-slots of the frame, each individual connector may move independently of other connectors. If a connector moves while the user is attempting to connect the bolt from the piece of equipment thereto, then it may be very difficult if not impossible to make the proper connection.

A need, therefore, exists for improved T-slot connector apparatuses. Specifically, a need exists for improved T-slot connector apparatuses that allow for easier connection of equipment to T-slot frames.

Moreover, a need exists for improved T-slot connector apparatuses that more easily and efficiently align T-slot connectors with equipment that may be attached to T-slot frames. More specifically, a need exists for improved T-slot connector apparatuses that align a plurality of connectors together at the same time, thereby allowing connectors to align and connect quickly and easily.

In addition, a need exists for improved T-slot connectors that are slidable within T-slots but may hold their position better when in a desired position. More specifically, a need exists for improved T-slot connectors that align and hold a plurality of apertures in place within a T-slot to connect a plurality of bolts thereto so that equipment may be connected more easily thereto.

### SUMMARY OF THE INVENTION

The present invention relates to T-slot connection insert apparatuses. Specifically, typical T-slot aluminum frame pieces include one or more slots contained within the frame pieces to hold one or more connectors that may be positioned to allow components to be connected thereto. The present invention provides a T-slot connection insert apparatus comprising a first connector tab having a first connection aperture therein and a second connector tab having a second connection aperture therein, wherein the first connector tab and the second connector tab are connected together via a bridging span.

To this end, in an embodiment of the present invention, A T-slot connection insert apparatus comprising: a first tab comprising a first surface and a first threaded aperture within the first surface; a second tab comprising a second surface and a second threaded aperture within the second surface; and a first bridging span between the first tab and the second tab, wherein the bridging span is connected to the first tab via a first connector.

In an embodiment, the first connectors is a rivet.

In an embodiment, the T-slot connection insert apparatus further comprises: a first pin disposed within a first aperture on a side of the first tab, the first pin further disposed within a second aperture on a side of the first bridging span.

In an embodiment, the first pin is removable from at least one of the first aperture and the second aperture.

In an embodiment, the first tab is removable from the first bridging span and the second tab is removable from the first bridging span.

In an embodiment, the T-slot connection insert apparatus further comprises a first magnet disposed in a location selected from the group consisting of a side of the first tab and a side of the first bridging span.

In an embodiment, the T-slot connection insert apparatus further comprises: a first magnet disposed in a side of the first tab; and a magnetically attractive material disposed in a side of the first bridging span.

In an embodiment, the magnetically attractive material disposed in the side of the first bridging span is selected from the group consisting of a metal and a permanent magnet.

In an embodiment, the first bridging span is connected to the second tab via a connector.

In an embodiment, the T-slot connection insert apparatus further comprises a bridging tab connected to the first bridging span via a second connector; a second bridging span disposed between the bridging tab and the second tab.

In an embodiment, the second bridging span is connected to the second tab via a connector.

In an embodiment, the bridging tab comprises a third surface and a third threaded aperture disposed in the third surface.

In an embodiment, the T-slot connection insert apparatus further comprises a spring-loaded ball plunger disposed on a bottom surface of the apparatus.

In an embodiment, the spring-loaded ball plunger extends from a bottom surface of the first tab.

In an embodiment, the spring-loaded ball plunger extends from a bottom surface of the first bridging span.

In an alternate embodiment of the present invention, a method of using a T-slot connection insert apparatus is provided. The method comprises the steps of: providing A T-slot connection insert apparatus comprising a first tab comprising a first surface and a first threaded aperture within the first surface; a second tab comprising a second surface and a second threaded aperture within the second surface; and a first bridging span between the first tab and the second tab, wherein the bridging span is connected to the first tab via a first connector; providing a tube comprising a T-slot; disposing the T-slot connection apparatus within the T-slot; and connecting an object to the T-slot connection apparatus within the T-slot.

In an embodiment, the method further comprising the steps of: removing the first bridging span from between the first tab and the second tab; and adding a second bridging span between the first tab and the second tab.

In an embodiment, the second bridging span has a different length than the first bridging span.

In an embodiment, the method further comprises the step of: removing the first tab from the first bridging span; and adding a third tab to the first bridging span in place of the first tab.

In an embodiment, the third tab comprises a different sized threaded aperture than the first tab.

It is, therefore, an advantage and objective of the present invention to provide improved T-slot connector apparatuses.

Specifically, it is an advantage and objective of the present invention to provide improved T-slot connector apparatuses that allow for easier connection of equipment to T-slot frames.

Moreover, it is an advantage and objective of the present invention to provide improved T-slot connector apparatuses that more easily and efficiently align T-slot connectors with equipment that may be attached to T-slot frames.

More specifically, it is an advantage and objective of the present invention to provide improved T-slot connector apparatuses that align a plurality of connectors together at the same time, thereby allowing connectors to align and connect quickly and easily.

In addition, it is an advantage and objective of the present invention to provide improved T-slot connectors that are slidable within T-slots but may hold their position better when in a desired position.

More specifically, it is an advantage and objective of the present invention to provide improved T-slot connectors that align and hold a plurality of apertures in place within a T-slot to connect a plurality of bolts thereto so that equipment may be connected more easily thereto.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a prior art T-Slot frame piece.

FIG. 2 illustrates a prior art T-slot frame.

FIG. 3 illustrates prior art T-slot connector nuts.

FIG. 4 illustrates a prior art T-slot connector nut disposed within a T-slot on a frame piece.

FIG. 5 illustrates a prior art piece of equipment, namely a motor, mounted to a T-slot frame piece via T-slot connector nuts.

FIG. 6 illustrates a front side of a T-slot connection insert apparatus in an embodiment of the present invention.

FIG. 7 illustrates a rear side of a T-slot connection insert apparatus in an embodiment of the present invention.

FIG. 8 illustrates a T-slot framing piece comprising a T-slot connection insert apparatus disposed within a T-slot thereof in an embodiment of the present invention.

FIG. 9 illustrates a prior art mounting bracket.

FIG. 10 illustrate a prior art mounting bracket connected to a T-slot connection insert apparatus disposed within a T-slot of a T-slot framing piece.

FIG. 11 illustrates a T-slot connection insert apparatus in an alternate embodiment of the present invention.

FIG. 12 illustrates a T-slot connection insert apparatus in an alternate embodiment of the present invention.

FIG. 13 illustrates a side profile view of a T-slot connection insert apparatus in an alternate embodiment of the present invention.

FIG. 14 illustrates a side profile view of a T-slot connection apparatus in an embodiment of the present invention.

FIG. 15 illustrates a top view of a T-slot connection apparatus in an embodiment of the present invention.

FIG. 16 illustrates an exploded perspective view of a T-slot connection apparatus in an embodiment of the present invention.

FIG. 17 illustrates a top view of a T-slot connection apparatus in yet another alternate embodiment of the present invention.

FIG. 18 illustrates a side profile view of a T-slot connection apparatus in another alternate embodiment of the present invention.

FIG. 19 illustrates an exploded perspective view of a T-slot connection apparatus in another alternate embodiment of the present invention.

FIG. 20 illustrates a top view of a T-slot connection apparatus in another alternate embodiment of the present invention.

FIG. 21 illustrates a T-slot having a T-slot connection apparatus disposed therein in an embodiment of the present invention.

FIG. 22 illustrates a perspective view of a T-slot connection apparatus comprising magnetic connectors in an alternate embodiment of the present invention.

FIG. 23 illustrates a bottom view of a T-slot connection apparatus in an alternate embodiment of the present invention.

FIG. 24 illustrates a top exploded view of a T-slot connection apparatus in an alternate embodiment of the present invention.

FIG. 25 illustrates a bottom exploded view of a T-slot connection apparatus in an alternate embodiment of the present invention.

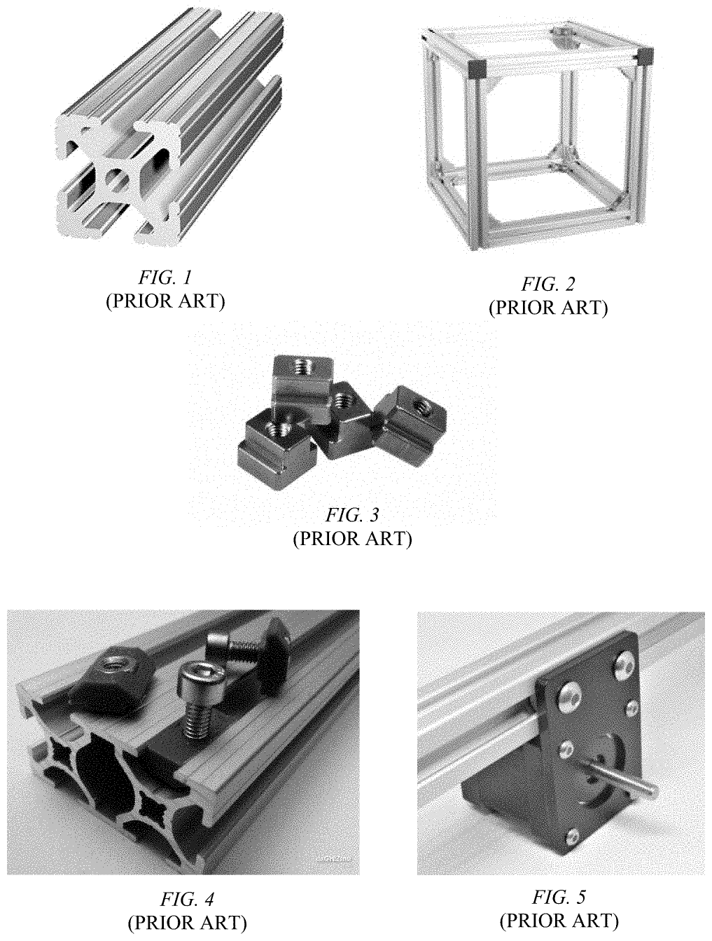

### DETAILED DESCRIPTION OF THE PRESENTLY PREFERRED EMBODIMENTS

The present invention relates to T-slot connection insert apparatuses. Specifically, typical T-slot aluminum frame pieces include one or more slots contained within the frame pieces to hold one or more connectors that may be positioned to allow components to be connected thereto. The present invention provides a T-slot connection insert apparatus comprising a first connector tab having a first connection aperture therein and a second connector tab having a second connection aperture therein, wherein the first connector tab and the second connector tab are connected together via a bridging span.

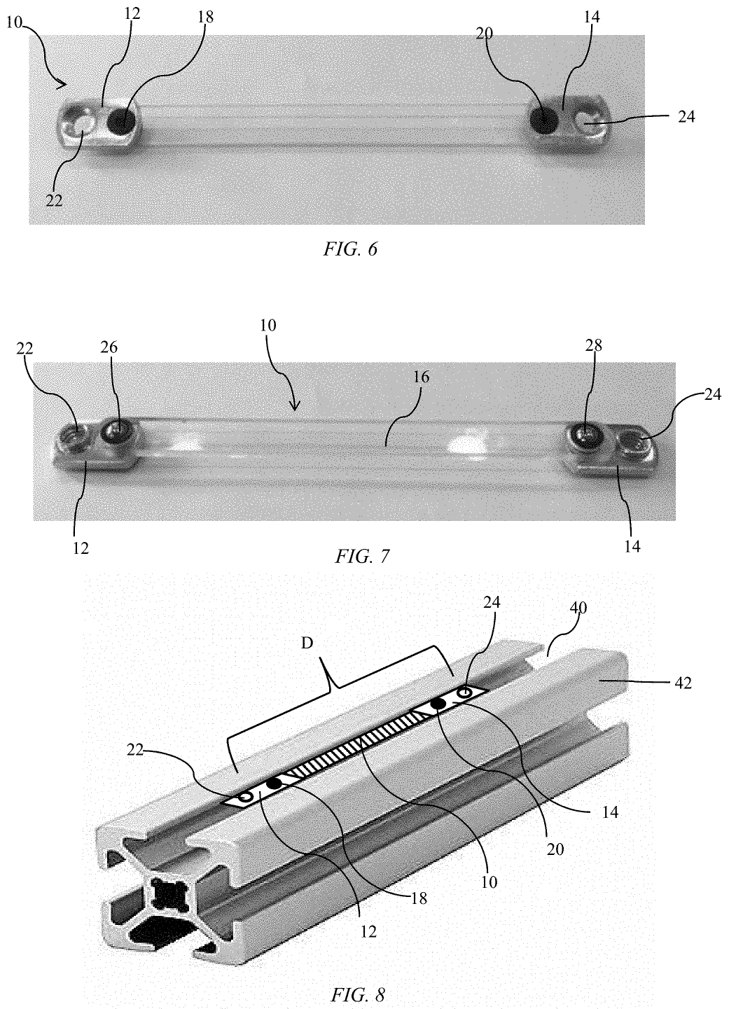

Now referring to the figures, wherein like numerals refer to like parts, a T-slot connection insert apparatus 10 is illustrated in FIG. 6. The T-slot connection insert apparatus comprises a first tab 12 and a second tab 14 connected on opposite ends of a bridging span 16 via first and second connectors 18, 20, respectively. The connectors may be any connector that connects the first and second tabs 18, 20 to one or more bridging spans 16, such as rivets or the like. Preferably, the connectors 18, 20, and other connectors described herein, allow for rotation of the first and second tabs 12, 14 relative to the bridging spans 16.

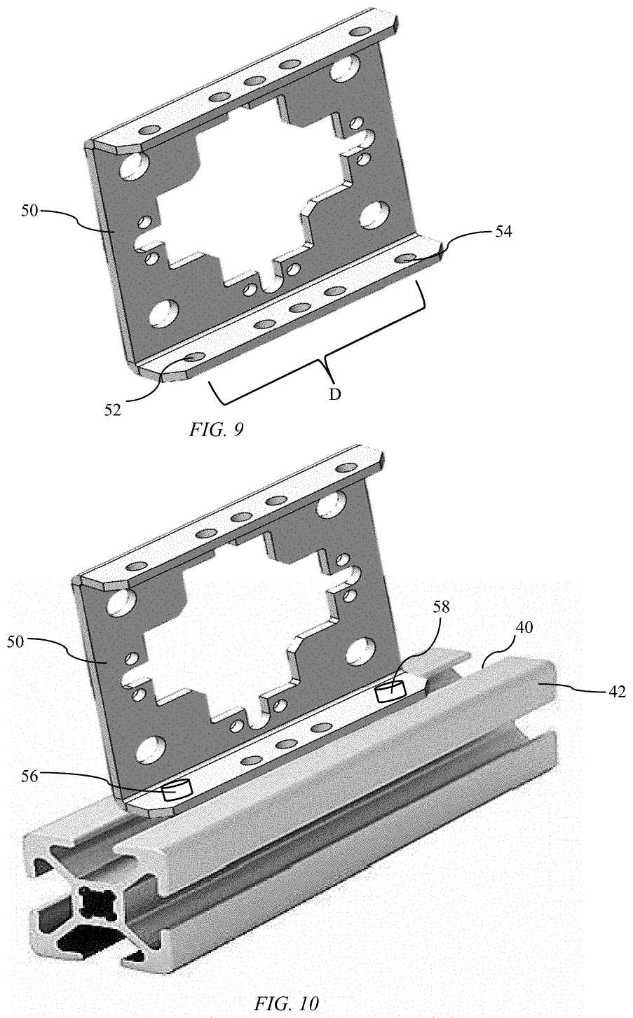

As illustrated, a first threaded aperture 22 may be disposed within the first tab 12 and a second threaded aperture 24 may be disposed in the second tab 14. The first and second threaded apertures may receive threaded bolts for holding attachable items in place on a T-slot frame piece when disposed within a T-slot thereof, as illustrated in FIGS. 8 and 9.

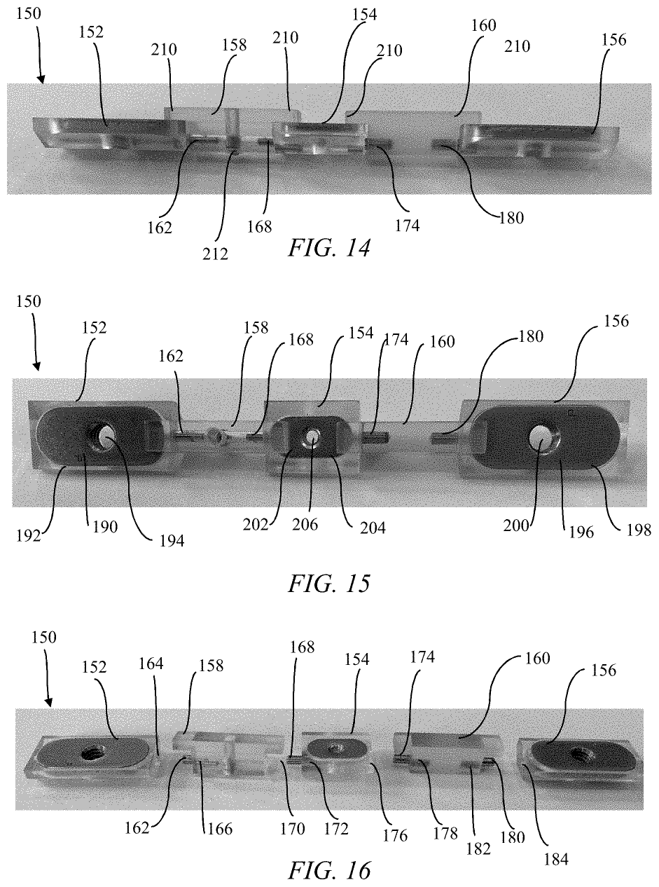

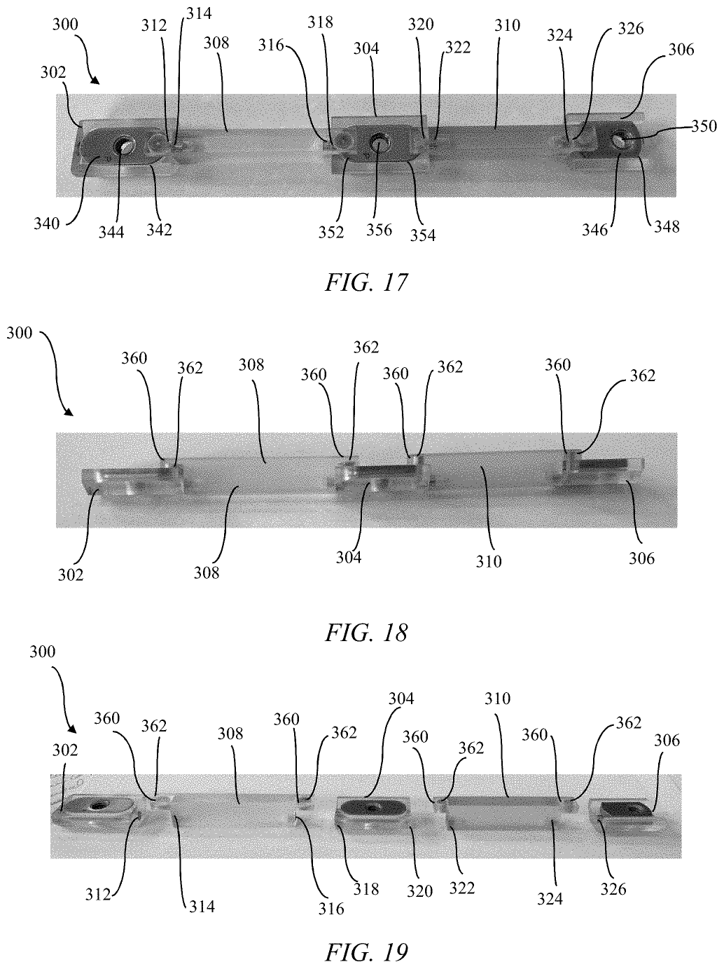

The first tab 12 and the second tab 14 may be made from metal, plastic, composite materials, or any other material apparent to one of ordinary skill in the art. The first and second connectors 18, 20 may be disposed through the first and second tabs 12, 14 and hold the first and second tabs 12, 14 to opposite ends of the bridging span 16. Alternatively, the first and second tabs 12, 14 may be removably attached to the bridging span 16 so that the different sized bridging spans may be utilized so that the distance between the first and second tabs 12, 14 and, therefore, the distance between first and second threaded apertures 22, 24 may be changed as desired. For example, tabs may be removably attached to one or more bridging span via pins, as shown in FIGS. 14-16, as detailed below. Alternatively, tabs may be removably attached to one or more bridging spans via magnets, as illustrated in FIGS. 17-20, as detailed below. Likewise, the bridging span 16 may be made from any material, such as metal, plastic, composite materials or the like, as apparent to one of ordinary skill in the art.

FIG. 7 illustrates a bottom view of the T-slot connection insert apparatus 10. On a bottom surface of the first and second tabs 12, 14, respectively, may be first and second spring-loaded ball plungers 26, 28 that may be held in place and spring back when pressed. The ball plungers may provide tension against a bottom of a T-slot in which the T-slot connection insert apparatus 10 is placed.

When disposed within a T-slot 40 of a T-slot framing piece 42, as illustrated in FIG. 8, the T-slot connection insert apparatus 10 holds the tabs 12, 14 apart from each other so that the first and second threaded apertures 22, 24 are held in place a distance “D” from one another. By holding the first and second tabs 12, 14 apart from each other so that the first and second threaded apertures 22, 24 are held in place a distance “D” from each other, a workpiece may be connected thereto having connection apertures that match the distance “D” so that the workpiece may be connected to the T-slot connection insert apparatus 10 and, more specifically, the first and second threaded apertures 22, 24 disposed within first and second tabs 12, 14 thereof.

Specifically, FIG. 9 illustrates a workpiece 50 that may be utilized with the present invention. More specifically, workpiece 50 may be a mount for mounting a piece of equipment, such as a motor mount or other like mount for mounting equipment thereto. The workpiece 50 may have a first connection aperture 52 and a second connection aperture 54 that are set the distance “D” apart from one another. Thus, workpiece 50 may be held to the T-slot framing piece 42 via connection to the T-slot connection insert apparatus 10 by bolts 56, 58, respectively, through first and second connection apertures 52, 54 and into first and second threaded apertures 22, 24 within first and second tabs 12, 14, respectively of the T-slot connection insert apparatus 10.

Therefore, workpiece 50 may be easily connected to the first and second tabs 12, 14 because the first and second tabs 12, 14 are held in place via bridging span 16. A user need not attempt to align both the first tab 12 and the second tab 14 independently of one another, and may have the first and second threaded apertures 22, 24 perfectly aligned with each other within the T-slot 40 of the framing piece 42.

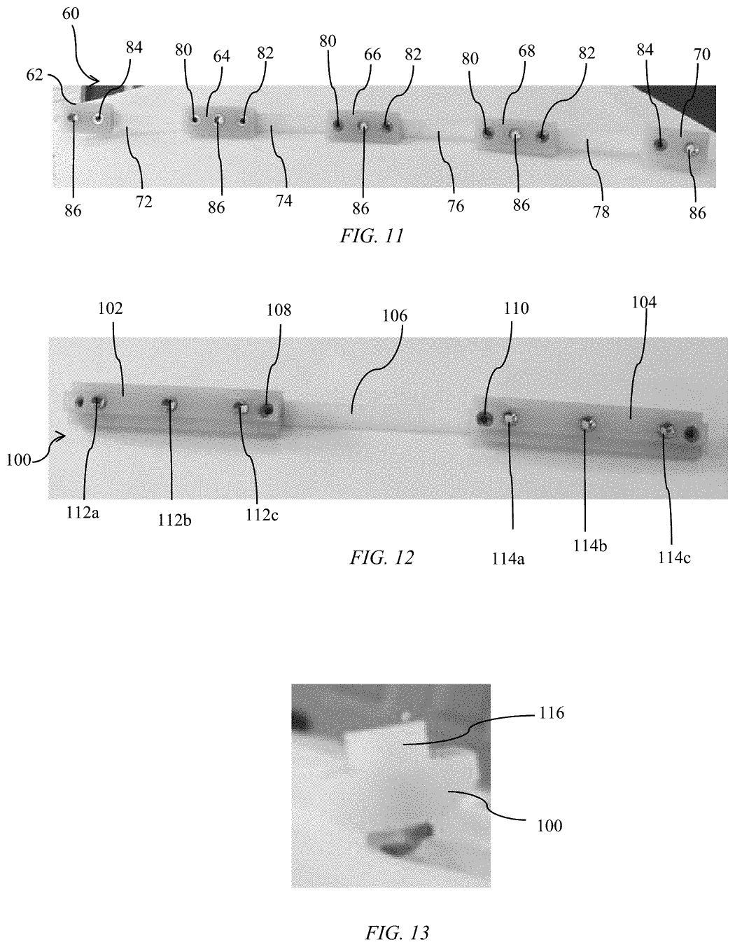

FIG. 11 illustrates a T-slot connection insert apparatus 60 in an alternate embodiment of the present invention. The T-slot connection insert apparatus 60 may have a plurality of tabs 62, 64, 66, 68 and 70, connected in series via a plurality of bridging spans 72, 74, 76, 78 disposed therebetween. Specifically, bridging span 72 may span between first and second tabs 62, 64, respectively; bridging span 74 may span between second and third tabs 64, 66, respectively; bridging span 76 may span between third and fourth tabs 66, 68, respectively; and bridging span 78 may span between fourth and fifth tabs 68, 70, respectively.

Second, third and fourth tabs 64, 66, 68, respectively, may have first and second connectors 80, 82 therein for connecting to respective bridging spans, and thus may be connected to the respective bridging spans at two locations on the second, third and fourth tabs 64, 66, 68, respectively. First tab 62 and fifth tab 70 may be end tabs, only have 1 connector 84 therein for connecting to a respective bridging span. Each of the tabs 62, 64, 66, 68, 70 may have one or more threaded apertures 86 therein for connecting a workpiece thereto. In addition, although not shown in FIG. 11, a plurality of ball plungers or other springs may be disposed on a bottom surface thereof to allow the T-slot connection insert apparatus 60 to be removably held in place within a T-slot of a T-slot framing piece.

Thus, the tabs and bridging spans may operate together to provide discrete connection points as needed for the workpiece. To accomplish this, the bridging spans 72, 74, 76, 78 may be of various lengths as needed to provide the threaded apertures in desired locations within a T-slot of a T-slot framing piece to connect to the workpiece.

FIG. 12 illustrates an alternate embodiment of the present invention of a T-slot connection insert apparatus 100 comprising a first tab 102 and a second tab 104 held in place relative to each other via bridging span 106. Connectors 108, 110 may connect the first and second tabs 102, 104 to opposite ends of the bridging span 106. Instead of a single threaded aperture in each of the first and second tabs 102, 104, there may be a plurality of threaded apertures 112a, 112b, 112c and 114a, 114b, 114c, disposed in the first and second tabs 102, 104. The plurality of threaded apertures 112a, 112b, 112c, 114a, 114b, 114c may provide many possibilities for connecting workpieces thereto. As noted above, a plurality of ball plungers (not shown) may extend from the T-slot connection insert apparatus 100 to hold the T-slot connection insert apparatus 100 in place within a T-slot of a framing piece.

FIG. 13 illustrates a side view of the T-slot connection insert apparatus 100, illustrating an extended platform 116 that may extend from the T-slot connection insert apparatus 100 to allow the T-slot connection insert apparatus 100 to provide a surface flush or nearly flush with the surface of a T-slot framing piece. The extended platform 116 may be any height, and may therefore make it easier to connect various workpieces to the threaded apertures therein.

In an embodiment of the present invention, a user may be provided the various pieces, and may construct a T-slot connection insert apparatus that is sized properly to fit connection apertures within a workpiece, as desired. The bridging span connecting first and second tabs may be cut to size to ensure that the threaded apertures within the first and second tabs precisely line up with connection apertures within the workpieces, as needed. Moreover, as illustrated below with respect to FIGS. 14-21, various elements of the T-slot connection insert apparatuses of the present invention may be modular and removably connectable to each other, so that the needed tabs and/or bridging spans may be utilized as necessary for any particular application.

For example, as illustrated in FIGS. 14-16, an alternate embodiment of a T-slot connection apparatus 150 is illustrated. The T-slot connection apparatus 150 is illustrated with a first end tab 152, a bridging tab 154, and a second end tab 156. Although only a single bridging tab 154 is illustrated, it should be apparent that any number of bridging tabs may be disposed between the first and second end tabs 152, 156, as needed. Moreover, a first bridging span 158 may span between first end tab 152 and bridging tab 154 and a second bridging span 160 may span between bridging tab 154 and second end tab 156.

The tabs, as described herein, may be removably connected to the bridging spans via pins, as shown in FIGS. 14-16. Specifically, a first pin 162 may connect the first end tab 152 to the first bridging span 158, disposed within a first aperture 164 within a first side of the first end tab 152 and a second aperture 166 within a first side of the bridging span 158. Likewise, a second pin 168 may connect the first bridging span 158 to the bridging tab 154, disposed within a third aperture 170 within a second side of the bridging span 158 and a fourth aperture 172 within a first side of the bridging tab 154. Moreover, a third pin 174 may connect the second bridging span 160 to the bridging tab 154, disposed within a fifth aperture 176 within a second side of the bridging tab 154 and a sixth aperture 178 within a first side of the second bridging span 160. Further, a fourth pin 180 may connect the second bridging span 160 to the second end tab 156, disposed within a seventh aperture 182 within a second side of the second bridging span 160 and an eighth aperture 184 within a first side of the second end tab 156. The pins 162, 168, 174 and 180 may temporarily hold the various elements together, but the various elements, such as the tabs and the bridging spans, may be removable from each other by pulling the pieces apart from each other, wherein the pins will be removed from respective apertures. Thus, different types and sizes of tabs and bridging spans may be exchanged, as needed and desired.

First end tab 152 may have a first insert 190, which may be disposed within a first inset area 192 therein, and the first insert 190 may have a first threaded aperture 194 therein for receiving a bolt or connector, as described above. Likewise, second end tab 156 may have a second insert 196 disposed within a second inset area 198 and may have a second threaded aperture 200 therein for receiving a bolt or connector. Moreover, bridging tab 154 may have a third insert 202 disposed within a third inset area 204 and may have a third threaded aperture 206 therein for receiving a bolt or connector. The first, second and third threaded apertures 194, 200, 206 may be any size as needed. Moreover, first, second and third inserts 190, 196, 202 may also be removable and swapped for other inserts having different sized apertures, as desired. Overlapping flanges 210 may extend from first and second bridging spans 158, 160 that may hold the inserts 190, 196, 202 in place within each respective inset area 192, 198 and 204 when disposed within a T-slot.

Disposed on a bottom of first bridging span 158 may be a spring-loaded ball plunger 212 that may hold the T-slot connection apparatus 150 within the T-slot, inhibiting movement of the same when disposed therein.

In yet another alternate embodiment of the present invention, a T-slot connection apparatus 300 is illustrated. The T-slot connection apparatus 300 is illustrated with a first end tab 302, a bridging tab 304, and a second end tab 306. Although only a single bridging tab 304 is illustrated, it should be apparent that any number of bridging tabs may be disposed between the first and second end tabs 302, 306, as needed. Moreover, a first bridging span 308 may span between first end tab 302 and bridging tab 304 and a second bridging span 310 may span between bridging tab 304 and second end tab 306.

The tabs, as described herein, may be removably connected to the bridging spans via magnets, as shown in FIGS. 17-19. Specifically, a first magnet 312 disposed within a first side of the first end tab 302 may be magnetically and removably connected to a second magnet 314 within a first side of the first bridging span 308. (Either of the first or second magnets 312, 314 may be merely metallic, as opposed to naturally magnetic, thereby providing induced magnetic attraction to the magnets). Likewise, a third magnet 316 within a second side of the first bridging span 308 may be magnetically and removably connected to a fourth magnet 318 within a first side of the bridging tab 304. Moreover, a fifth magnet 320 within a second side of the bridging tab 304 may be magnetically and removably connected to a sixth magnet 322 within a first side of the second bridging span 310. Further, a seventh magnet 324 within a second side of the second bridging span 310 may be magnetically and removably connected to an eighth magnet 326 within a first side of the second end tab 306. Thus, each of the tabs and bridging spans may be serially disposed together and magnetically and removably connected to form a chain of elements, as illustrated in FIGS. 17 and 18.

First end tab 302 may have a first insert 340, which may be disposed within a first inset area 342 therein, and the first insert 340 may have a first threaded aperture 344 therein for receiving a bolt or connector, as described above. Likewise, second end tab 306 may have a second insert 346 disposed within a second inset area 348 and may have a second threaded aperture 350 therein for receiving a bolt or connector. Moreover, bridging tab 304 may have a third insert 352 disposed within a third inset area 354 and may have a third threaded aperture 356 therein for receiving a bolt or connector. The first, second and third threaded apertures 344, 350, 356 may be any size as needed. Moreover, first, second and third inserts 340, 346, 352 may also be removable and swapped for other inserts having different sized apertures, as desired. Overlapping flanges 360 may extend from first and second bridging spans 308, 310 that may hold the inserts 340, 346, 352 in place within each respective inset area 342, 348 and 354 when disposed within a T-slot. Likewise, each overlapping flange 360 may have a magnet 362 disposed therein so that the same may be magnetically and removably connected to the first, second and third inserts 340, 346, 352, respectively, thereby holding the first, second and third inserts 340, 346, 352 within respective insets 342, 348, 354, when disposed within the T-slot.

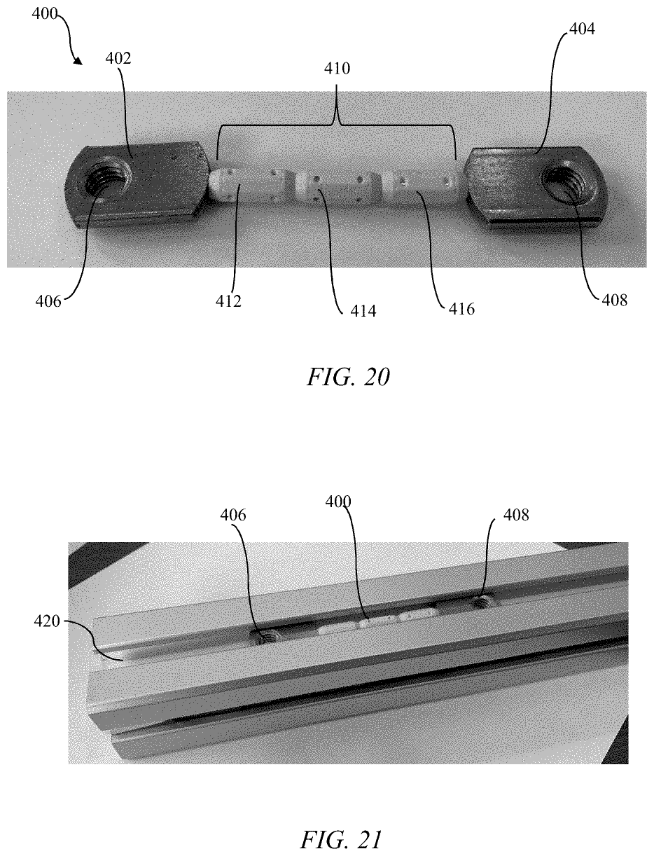

In an alternate embodiment of the present invention, a T-slot connection apparatus 400 is illustrated and described herein. The T-slot connection apparatus comprises a first tab 402 and a second tab 404. The first tab 402 has a first threaded aperture 406 therein and the second tab has a second threaded aperture 408 therein. Disposed between and forming a bridging span 410 is a plurality of magnetic rods 412, 414, 416 disposed in serial arrangement. The bridging span 410 is magnetically and removably connected to the first tab 402 and the second tab 404 on opposite ends thereof. Because the bridging span 410 is made of the plurality of magnetic rods, any number of magnetic rods may be utilized and serially disposed to form the bridging span 410, depending on the desired length of the bridging span 410. In other words, although three magnetic rods 412, 414, 416 are illustrated I FIG. 20, any number, from one or more, may be utilized to form the bridging span 410, as needed. Likewise, end tabs and bridging tabs may be also be utilized to provide as many threaded apertures as needed for a give application. FIG. 21 illustrates T-slot connection apparatus 400 disposed within a T-slot 420, providing connection points where first and second threaded apertures 406, 408 are disposed.

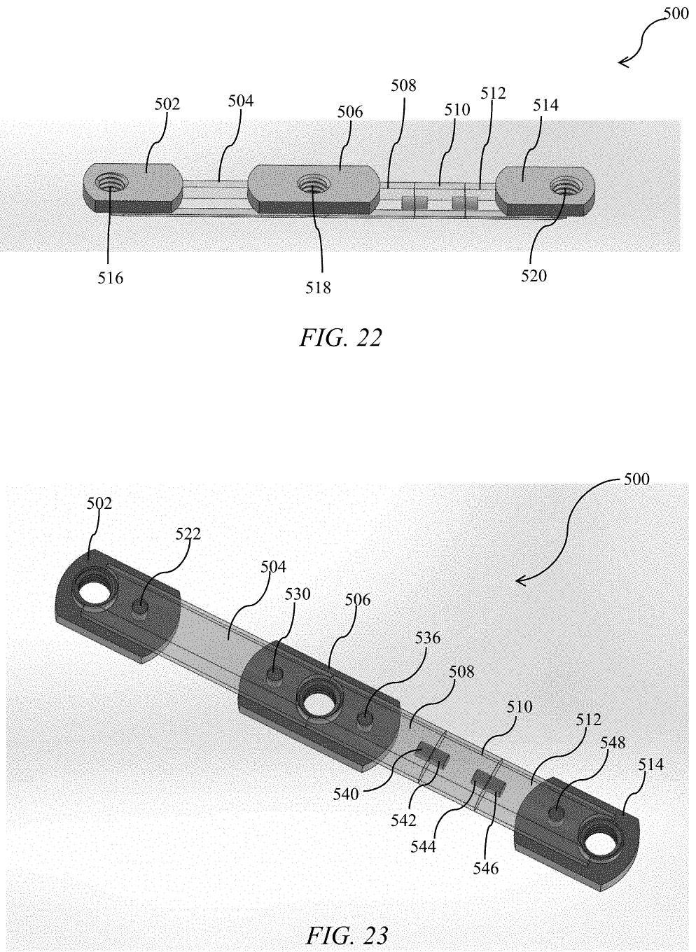

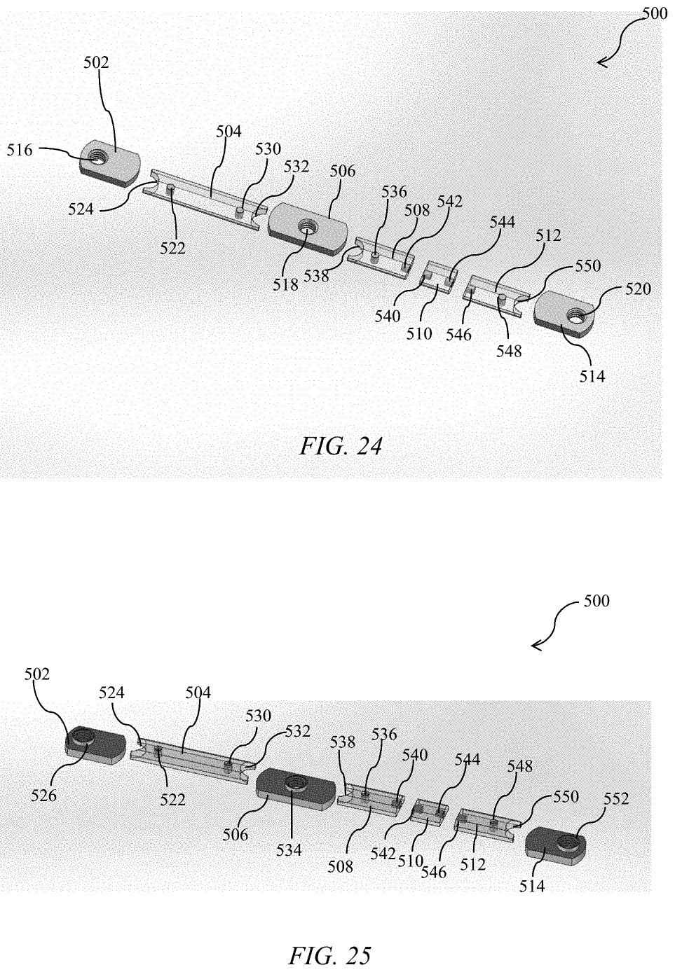

Referring now to FIGS. 22-25, an alternate embodiment of a T-slot connection apparatus 500 is illustrated and described herein. The T-slot connection apparatus 500 comprises a first end tab 502 magnetically connected via a first bridging span 504 to a bridging tab 506 on a first side thereof, and connected on a second side thereof to a second bridging span 508 having an extension span 510 magnetically connected thereto on a first side of the extension span 510 and magnetically connected on a second side of the extension span 510 to a third bridging span 512, which is in turn magnetically connected to a second end tab 514. The various magnets and magnetic connections are illustrated in FIG. 23, a bottom view of the T-slot connection apparatus 500.

The first end tab 502 may comprise a first threaded aperture 516, the bridging tab 506 may comprise a second threaded aperture 518, and the second end tab 514 may comprise a third threaded aperture 520. While T-slot connection apparatus 500 illustrates a specific number of end tabs, bridging tabs, bridging spans and extension spans, it should be noted that the T-slot connection apparatus may comprise any number of the same as needed to fit within T-slots for providing as many discrete connecting points as needed to connect items thereto while disposed within a T-slot.

As illustrated in FIG. 23, the first end tab 502 may be magnetically connected to the first bridging span 504 via a magnetic element 522 embedded within a surface on or near a first end of the first bridging span 504. The magnetic element may be a small permanent magnet that may have a magnetic attraction to first end tab 502, which may be made, at least in part, from a ferromagnetic material. Alternatively, the first end tab 502 may have a second magnetic element (not shown) within the first end tab 502 to which magnetic element 522 is attracted. The first bridging span 504 may further have a first end having a semi-circular indentation 524 to engage with a circular rim 526 that runs a perimeter around the threaded aperture 516 on a bottom of the first end tab 502. Thus, by engaging the semi-circular indentation 524 with the rim 526 and engaging the magnetic element 522 with the first end tab 502, the bridging span 504 may be held in place in magnetic adherence to the first end tab 502.

The bridging span 504 may have a second magnetic element 530 on or near a second end thereof that may impart a magnetic attraction to the bridging tab 506. The second end of the first bridging span 504 may also have a semi-circular indentation 532 to engage with circular rim 534 that runs a perimeter around the threaded aperture 518 on a bottom of the bridging tab 506.

Second bridging span 508 may also include a magnetic element 536 on or near a first end thereof that may impart a magnetic attraction to the bridging tab 506. The first end of the second bridging span 508 may have a semi-circular indentation 538 to engage with circular rim 534 running the perimeter around the threaded aperture 518. However, the second end of the second bridging span 508 may be straight, or another shape, and may magnetically adhere to a respective straight end of the extension span 510. A magnetic element 540 may be disposed within the second end of the second bridging span 508 to engage a magnetic element 542 disposed within a first straight end of the extension span 510. A second straight end of extension span 510 may have magnetic element 544 to engage a magnetic element 546 disposed with a respective straight end of third bridging span 512.

Third bridging span 512 may further comprise a magnetic element 548 on or near a second end thereof, which may also have a semi-circular indentation 550 for engaging with circular rim 552 running a perimeter around the threaded aperture 520 of second end tab 514.

Thus, the T-slot connection apparatus 500 may be slid within a T-slot and used to engage with elements within the threaded apertures 516, 518, 520. As noted above, the various elements described herein may be connected together with the respective magnetic elements to form any length apparatus, with any number of threaded apertures, as desired.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

I claim:

1. A T-slot connection insert apparatus comprising:
a first tab comprising a first surface and a first threaded aperture within the first surface;
a second tab comprising a second surface and a second threaded aperture within the second surface;
and a first bridging span between the first tab and the second tab, wherein the bridging span is connected to the first tab via a first connector.

2. The T-slot connection insert apparatus of claim 1 wherein the first connectors is a rivet.

3. The T-slot connection insert apparatus of claim 1 further comprising:
a first pin disposed within a first aperture on a side of the first tab, the first pin further disposed within a second aperture on a side of the first bridging span.

4. The T-slot connection insert apparatus of claim 3 wherein the first pin is removable from at least one of the first aperture and the second aperture.

5. The T-slot connection insert apparatus of claim 1 wherein the first tab is removable from the first bridging span and the second tab is removable from the first bridging span.

6. The T-slot connection insert apparatus of claim 1 further comprising:
a first magnet disposed in a location selected from the group consisting of a side of the first tab and a side of the first bridging span.

7. The T-slot connection insert apparatus of claim 1 further comprising:
a first magnet disposed in a side of the first tab; and
a magnetically attractive material disposed in a side of the first bridging span.

8. The T-slot connection insert apparatus of claim 7 wherein the magnetically attractive material disposed in the side of the first bridging span is selected from the group consisting of a metal and a permanent magnet.

9. The T-slot connection insert apparatus of claim 1 wherein the first bridging span is connected to the second tab via a connector.

10. The T-slot connection insert apparatus of claim 1 further comprising:
a bridging tab connected to the first bridging span via a second connector;
a second bridging span disposed between the bridging tab and the second tab.

11. The T-slot connection insert apparatus of claim 10 wherein the second bridging span is connected to the second tab via a connector.

12. The T-slot connection insert apparatus of claim 10 wherein the bridging tab comprises a third surface and a third threaded aperture disposed in the third surface.

13. The T-slot connection insert apparatus of claim 1 further comprising:
a spring-loaded ball plunger disposed on a bottom surface of the apparatus.

14. The T-slot connection insert apparatus of claim 13 wherein the spring-loaded ball plunger extends from a bottom surface of the first tab.

15. The T-slot connection insert apparatus of claim 13 wherein the spring-loaded ball plunger extends from a bottom surface of the first bridging span.

16. A method of using a T-slot connection insert apparatus comprising the steps of:
providing A T-slot connection insert apparatus comprising a first tab comprising a first surface and a first threaded aperture within the first surface; a second tab comprising a second surface and a second threaded aperture within the second surface; and a first bridging span between the first tab and the second tab, wherein the bridging span is connected to the first tab via a first connector;
providing a tube comprising a T-slot;
disposing the T-slot connection apparatus within the T-slot; and
connecting an object to the T-slot connection apparatus within the T-slot.

17. The method of claim 16 further comprising the steps of:
removing the first bridging span from between the first tab and the second tab; and
adding a second bridging span between the first tab and the second tab.

18. The method of claim 17 wherein the second bridging span has a different length than the first bridging span.

19. The method of claim 16 further comprising the step of:
removing the first tab from the first bridging span; and
adding a third tab to the first bridging span in place of the first tab.

20. The method of claim 19 wherein the third tab comprises a different sized threaded aperture than the first tab.
